(19) United States
(12) Patent Application Publication
(10) Pub. No.: US 2016/0158645 A1
(43) Pub. Date: Jun. 9, 2016

(54) SYSTEM AND METHOD FOR INPUTTING GAME NUMBERS

(71) Applicant: Ofir HAZAN, Nahariya (IL)

(72) Inventor: Ofir HAZAN, Nahariya (IL)

(21) Appl. No.: 14/562,715

(22) Filed: Dec. 7, 2014

(51) Int. Cl. A63F 13/35

(52) U.S. Cl. CPC A63F 13/35

(57) ABSTRACT

The subject matter discloses method, comprising accessing one or more social network website; accessing an online game; selecting one or more social connections from the social network website extracting social connection data of the one or more social connections from the social network website; generating participation data from the social connection data; wherein the participation data enables participating in the online game; and, inputting the one or more social connections into the online game.

### FIELD OF THE INVENTION

The subject matter relates generally to a system and method for inputting numbers into a game according to social network connections.

BACKGROUND OF THE INVENTION

The World Wide Web (“WWW”) has enabled people to connect regardless of distance and location of the various people. Social network websites enable the people to connect with others and share information. The people with which connection is possible may be real life friends, persons met online through the social network website that share a common interest, business associates, coworkers, and the like. The social network website enables people to share information with one another when making connections with other people using the social network website. For example, a person may share personal information such as images, birthdate, age, residence, employment, friends and the like. Social network websites provide different manners of interaction to people using the social network website, such as online games played by connections together, or events in which multiple connected users are present. For example, people with profiles on Facebook.com may interact by playing Farmville together and other multiplayer games.

Games, such as a lottery, require a person to select one or more numbers which have to be matched by the game moderators in order for the person to in prizes. Other games may require obtaining a combination of numbers, shapes, and colors to win the game. For example, getting a winning set of cards in poker, or a highest number in Black Jack. Some games, such as slots require matching three identical shapes to win. Winning in the games provides the person playing with different prizes ranging from cash to tangential goods, for example, jewelry or vehicles. These games have become prevalent in the online community. Individuals may participate in the games using computerized devices, such as laptops, tablets, smartphones, or the like. The games may provide the individuals with the opportunity to interact with other players in the games. For example, online poker players may chat in a chatroom of the online poker game the players are participating in.

U.S. Pat. No. 8,641,501 discloses a game of chance in which profile data for social contacts in a social networking system is used to determine whether a player wins or loses the game of chance. Social contacts are randomly selected from a group of social contacts. The social contacts may be obtained from a single data source or from multiple data sources and aggregated. A game player wins if the randomly selected social contacts have one or more profile attributes that match each other. The game may be presented as a slots based game in which profile pictures for the social contacts are the symbols for the reels of the slots game.

U.S. Pat. No. 5,139,270 discloses a new type of Bingo game for children wherein each of a plurality of player game cards is divided into a grid of not more than twenty-five equal areas arrayed in five rows and five columns in which are displayed in different grid areas on each card a combination of indicia consisting of not more than twenty predetermined different items each related to a single subject and at least five blank areas for designated and insertion by each player with his and the other players names. The word “BINGO” is written above the grid columns, spaced to permit each of its letters to identify a different column. Each player plays with at least one game card. Squares, discs or chips are sequentially and randomly selected from a group of squares, discs or chips which collectively match all players' names without their columnar locations and all predetermined indicia with their columnar locations. In response to the sequential selections and announcements of the players' names and, in the case is of predetermined indicia, the indicia and columnar locations, each player uses one of a supply of markers to cover the area on his game card that matches the item announced. The first player to cover five grid areas in a straight line either horizontally, vertically, or diagonally, becomes the winner and the game ends.

KR20110081471 discloses a Lotto number combination system is provided to increase the prediction rate of a Lotto winning number using the law of large numbers. CONSTITUTION: A biorhythm output unit (20) produces a biorhythm index according to the date of birth and stores the biorhythm index in a biorhythm DB (12). A purchase prediction unit (22) produces a purchase recommendation date and a purchase recommendation game number according to each client with reference to the biorhythm index. A message transfer unit (24) transmits the outputted purchase recommendation date and purchase recommendation game number to the mobile communication terminal of a client (5).

U.S. Pat. No. 5,118,110 discloses a lottery selection number game board includes a base board and a plurality of concentric arrays haying a common center. A first inner array has twelve spaces, one for the month and the second array has thirty-one spaces, one for each month day. The third and fourth arrays respectively include equispaced spaces, with one including numbers for a large lottery game and the other numbers for a small lottery game. Rotating pointers are mounted on a common center, with one aligned with a month space and the second aligned with the day to identify the user's birthdate. A third pointer is mounted for fee spin movement over the two lottery number arrays. The third pointer is manually spun by the player to complete the lottery number array and comes to rest within the number array to identify a number within the array for selecting a lottery number. Sequential spins are made to select a lottery number. U.S. Pat. No. 8,678,909 discloses a slot machine game that customizes winning combinations based on the player's year of birth. In this way, the player's gaming experience can be tailored to themes such as the Chinese Zodiac. The player's year of birth can be inputted directly into the machine or the machine can automatically query the casino database if the player uses his or her player's card to find out the year of birth.

### SUMMARY

It is an object of the subject matter to disclose a method, comprising: accessing one or more social network website; accessing an online game; selecting one or more social connections from the social network website; extracting social connection data of the one or more social connections from the social network website; generating participation data from the social connection data; wherein the participation data enables participating in the online game; and, inputting the one or more social connections into the online game.

In some cases the method further comprises generating participation data from connection information provided about a social connection of the one or more social connections from the social network website.

In some cases the connection information used to generate the participation data is a birth date of a social connection.

In some cases the generated participation data is randomly generated from the user account on the social network website.

In some cases the method further comprises displaying on the social network the social connections selected for the game.

In some cases the method further comprises determining a success probability of the social connection to generate winning participation data.

In some cases the online game is a lottery.

In some cases the online game is a card game.

In some cases the online game is to roulette.

In some cases the online game is bingo.

It is another object of the subject matter to disclose as computerized, device, comprising: an input for selecting a social connection from a social network website; a participation data generation unit for generating participation data that is used to participate in an online game; wherein the participation data is generated from the social connection; a communication unit to connect to a social network server to obtain access the social network website; wherein the communication unit connects to one or more online game servers to enable playing an online game; wherein playing the online game comprises inputting participation data to enable playing the online game; an output unit for displaying the one or more social connections selected as inputs for game input.

In some cases the selection of the one or more social connections is transmitted to the one or more social network servers.

### BRIEF DESCRIPTION OF THE DRAWINGS

Exemplary non-limited embodiments of the disclosed subject matter will be described, with reference to the following description of the embodiments, in conjunction with the figures. The figures are generally not shown to scale and any sizes are only meant to be exemplary and not necessarily limiting. Corresponding or like elements are optionally designated by the same numerals or letters.

FIG. 1 shows a system for providing numbers from social network connections, according to sonic exemplary embodiments of the subject matter;

FIG. 2 shows a computerized device for obtaining data to input into an online game, according to some exemplary embodiments of the subject matter;

FIG. 3 shows a method for providing connection data from a social network website to input into an online game, according to some exemplary embodiments of the subject matter;

FIG. 4A-4C show a display of selecting one or more connections as inputs for an online game, according to some exemplary embodiments of the subject matter: and,

FIG. 5 shows a connection selection display, according to some exemplary embodiments of the subject matter.

### DETAILED DESCRIPTION

The subject matter relates generally to a system and method for obtaining numbers for games, according to exemplary embodiments.

One technical problem dealt with by the disclosed subject matter subject matter is enabling a user to enhance the use of a social network website by playing an online game.

One technical solution according to the subject matter is enabling the user to select a user's social connections from the social network website as input for the online game. The user's social connections are selectable as input for the online game, for example, lotteries, card games, and the like. The social connection are selectable as inputs for the social game instead of choosing numbers. Choosing the social connections instead of numbers allows the user to create a social interaction from participating in the online game by selecting the social connections and then publicizing it on the social network website. The use of the social connections as inputs for online games is sharable in the social network website through a user's account, which shows a user's information and activity. For example the user's account enables the user to share information regarding a user's name, images, and status updates. The user's account also enables the user to share the social connections that were selected as input for the online game. Displaying the social connections used as input for the online game enhances a user's experience and enables social interaction amongst the user and the social connections. When one of the social connections provides a win in the online game, the information of a winning social connection may be shared on the user's account on the social network website. In some exemplary cases, the user may recommend the winning social connections to other social connections by displaying a message on the user's account of the winning social connection and the online game wan using the winning social connection.

In some exemplary embodiments of the subject matter, the user's account enables the user to view which user connections currently provide participation data in the online game, i.e. the user connection being used by other users of the social network website to generate participation data. For example, showing the list of the user connections currently used to generate participation data for an online roulette game for the other users of the social network website.

In some exemplary embodiments of the subject matter, the user's account shows which user connections generated winning participation data for the online game and the date when the win occurred. For example, the user's account shows that the user connection generated a winning number in an online lottery game on Dec. 8, 2012.

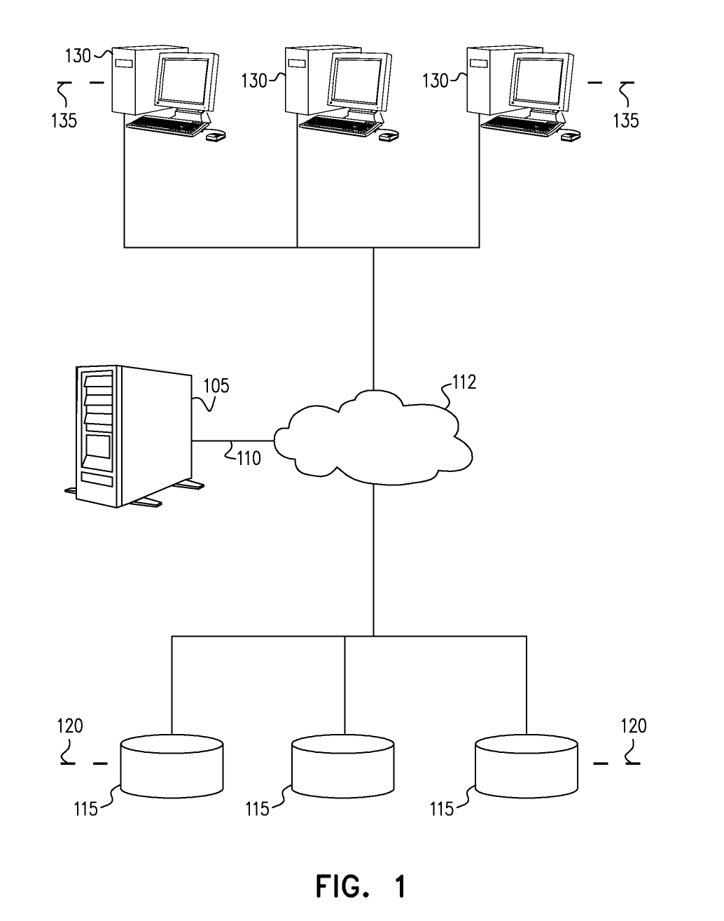

FIG. 1 shows a system for providing numbers from social network connections, according to some exemplary embodiments of the subject matter. The system 100 comprises a user computerized device 105, which is used by a user to access a social network website, for example, Facebook, Twitter, Tumblr, or the like. The user computerized device 105 may be a laptop, a tablet, a smartphone, or the like. The user computerized device 105 is connected to a computer network 110, such as a World Wide Web (“WWW”) 112. The computer network 110 comprises one or more social network servers 115, illustrated as three social network servers 115, representing any number of social network databases 115, as indicated by dashed lines 120. The social network databases 115 store data for the social network website. Each social network database of the one or more social network servers 115 comprise information about a user account that is provided when the user logs onto the social network website. The user account comprises information about the user, such a user's name, a user's birthdate, residence, contact information, and the like. The user's account comprises social connections of the user through the social network, for example, friends on Facebook, followers on Twitter or the like. The computerized device 105 enables the user to view a social connection account of the connection and social connection information.

The computer network 110 comprises one or more game servers 130, illustrated as three game servers 130, representing any number of game servers 130, as indicated by dashed lines 135. The one or more game servers 130 store online games that enables the user to play and win prizes, for example, the online games may be lottery, roulette, slot machine, bingo, card games, or the like. The user computerized device 105 connects to the gamer servers 130 to input participation data, such as numbers for a lottery cards for Texas Hold'em, or the like. The user uses the user computerized device 105 to view the social connection on the social network website and to select the social connection from the social network website. For example, selecting the social connection from a list of the social connections by clicking on an image of the social connection. When the social connection is selected, the computerized device 105 accesses a social connection data stored on the social network server 115 to generate the participation data for the online game. The user computerized device 105 inputs the participation data into the online game that the user is playing. The participation data is generated from data of the social network stored on the social network server 115. For example, the data is date of birth, age, or the like. In some cases, the participation data may be generated through an algorithm for generating the participation data from the information of the social connection, for example, numerology of a social connection's name.

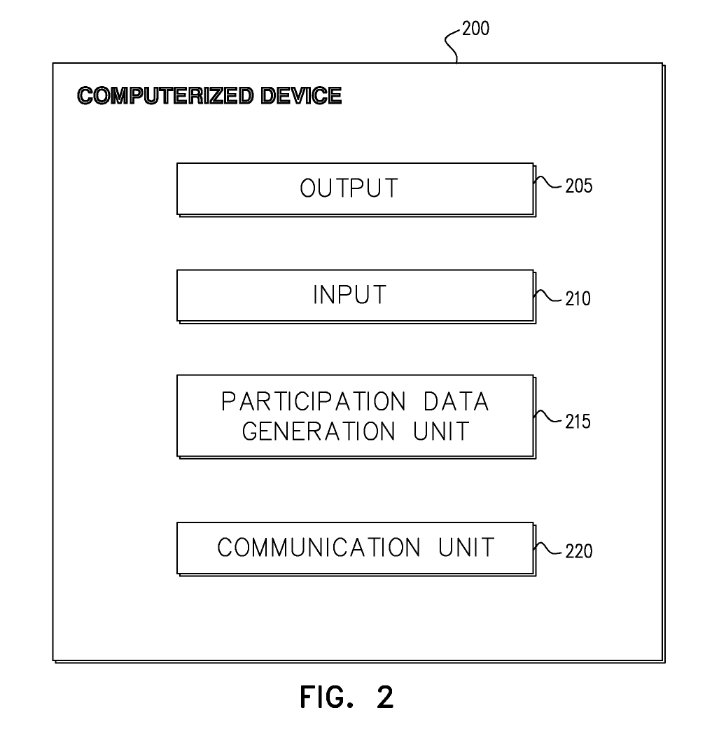

FIG. 2 shows a computerized device for obtaining data to input into an online game, according to sonic exemplary embodiments of the subject matter. The computerized device 200 comprises an output unit 205, such as a display. The computerized device 200 enables a user of the computerized device 105 to view websites, i.e. the computerized device 200 accessing the websites through the WWW 112 of FIG. 1. The computerized device 105 comprises an output unit 205, such as a display, which enables the user of the computerized device 105 to view the websites. The computerized device comprises a communication unit 220, which enables the computerized device 200 to access social network websites and online games by accessing the social network servers 115 of FIG. 1 and the online game servers 130 of FIG. 1, respectively. The computerized device 200 comprises an input 210, which enables the user of the computerized device 200 to input commands. The input 210 enables selecting user connections that are used as participation data for the online game. The computerized device 200 comprises a participation data generation unit 215, which generates participation data to be used to participate in the online game. For example, the user inputs social connections from a social network website, e.g. Facebook, to be used as input to the online game, e.g. a card game, the participation data generation unit 215 generates cards to be used in the card game obtained from selected social connections. For example, a deck comprising a set of 52 cards is numbered according to a predetermined scale, i.e. diamonds are numbered 1-12, clovers are numbered 13-24, hearts are numbered 25-36, spades are numbered 37-48 and jokers are 49-52. The participation data is generated to module the user connection information into a number on the scale to provide the card that represents the user connection.

In some exemplary embodiments of the subject matter, the computerized device may access a third party website through the WWW 112, for example an online gaming website. The third party website may access the social network server 115 to obtain the user connection to generate participation data. After the participation data is transmitted to the gaming server 135, the social connections used to generate the participation data are transmitted to the social network server 115. The social network server 115 inserts the social connections to the user account to create a message on the user account.

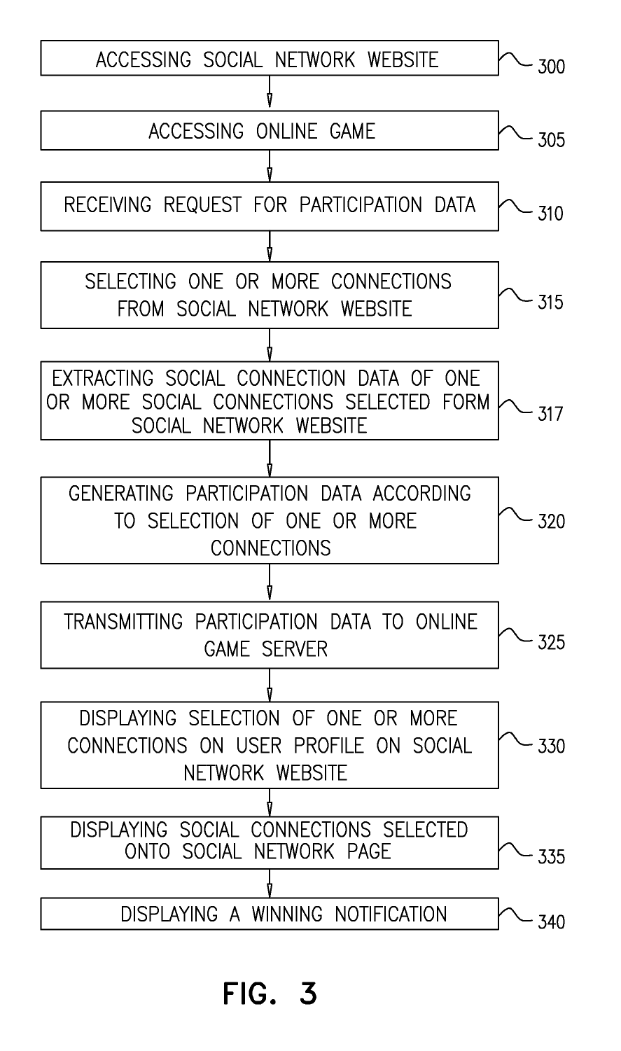

FIG. 3 shows a method for providing connection data from a social network website to input into an online game, according to some exemplary embodiments of the subject matter. Step 300 discloses accessing a social network website. The computerized device 105 of FIG. 1 connects to the one or more social network servers 130 of FIG. 1. The computerized device 105 accesses a server of the one or more social network servers 130, which stores a social network profile of a user using the computerized device 130. The computerized device 105 accesses the server of the one or more social network servers 130 to obtain information of a social connections from the social connections. For example, the user of the computerized device 105 accesses Facebook, i.e. the computerized device 105 connects to a Facebook server, which stores a user's Facebook profile and information related to the user's Facebook profile. The user using the computerized device 105 may access the user's personal information when connecting to the server of the one or more social network servers 130. The user's profile may comprise connections, which are profiles to which the user is connected to through the user's profile. The connections are user profiles of entities the user wants to be acquainted with, for example friends, family, business associates, coworkers, or the like.

Step 305 discloses accessing an online game. The computerized device 105 connects to one or more game servers 120 to access the game stored on the one or more game servers 120. For example, the user uses the computerized device 105 to play a lottery by accessing a lottery server of the one or more game servers 120.

Step 310 discloses receiving a request for an input from the online game server 130. The computerized device 105 receives a request for inputs for the online game to enable the user of the computerized device 105 to participate in the online game. For example, where the online game is a slot machine game the computerized device 105 receives a request for profile images of connections from the user's profile. Each game comprises a predetermined number of inputs requires, for example, a lottery requires six numbers to inputted to enable playing the lottery.

Step 315 discloses selecting one or more connections from the user's profile. The computerized device 105 obtains an input from the user of the computerized, device 105, which comprises the selection of the one or more connections. The user inputs a selection of social connections into the computerized device for example by clicking social connections displayed on the social network website by using a mouse to click on an image of the social connection. In some exemplary embodiments of the subject matter, the selection of the one or more connections is selected from a third party website, which enables accessing the social network website to obtain the one or more connections selected. For example, an online gaming website enables the user to select the one or more connections through the online gaming website, which accesses the social network servers 115 to obtain the social connections information.

Step 317 discloses extracting social connection data of the one or more social connections selected form the social network website. The type of social connection data is extracted from information provided and made available through the social connection website. For example, the social connection data may be the date of birth, age, name, height, social security number, or the like. In some cases, where the social network website enables the social connection to prevent disclosure of certain social connection data, such as the social connection does not provide the age of the social connection.

Step 320 discloses generating the participation data from the social connection data selected by the user. The computerized device 101 generates the participation data from the social connections selected. The generation is performed by obtaining information of the social connections, for example a birthdate, and generating the participation data. The participation data generated is in the format of the online game. For example, where the online game is a lottery, the participation data is numbers, or where the online game is a card game, the participation data is a card representation of the social connection. The participation data is generated according to predetermined algorithms for each online game, which enables generating the participation data from information available about the social connection on the social network website. For example, the online game for to lottery converts a social connection birthdate into a number that is used as participation data for the lottery. In some exemplary embodiments of the subject matter, the online games are number based games, where participation data generated is some number. For example, the generation of the participation data is by obtaining a birthdate and converting based on a module of the range of the numbers. For example, for the lottery game allows choosing a number between 1 and 63, the module would be the range of numbers from 1 to 63 that may be selected for participating in the lottery game, In some exemplary embodiments of the subject matter, the module is performed through combining the numbers of the user connection number together and scaling the number according, to a predetermined scale. For example, where the user plays a Powerball lottery, the user connection was born in year 1988. The year 1988 is summer, i.e. 26. The number is scaled according to the scale of 60 for the Powerball lottery.

Step 325 discloses analyzing the social connections to determine a success probability of generating a winning participation data. In some cases, the social connection has been selected by other users of the social network website to provide participation data that provided winning participation data of the other users. In such cases, the computerized device 105 may recommend the social connection as an optimal selection to be used as participation data in the online game. It should be noted that Step 320 is suggestive and not required for performance of the method.

Step 330 discloses transmitting the participation data to game server. The computerized device 105 transmits the participation data generated to the game server 105 to enable participation in the online game. The participation data is entered into the online game such that the user is now participating in the online game.

Step 335 discloses displaying social connections selected onto social network page. After the participation data is submitted for the online game, the social connections used to generate the participation data are arranged to be displayed on the user's social account. For example, posting a tweet on Tweeter showing the followers used to generate the participation data.

Step 340 discloses displaying a winning notification. After the online game is played, for example, in the lottery game, the winning numbers are drawn, a winner may be determined. Where participation data matches the winning, numbers, the winning notification is transmitted to the social network server 130 to update the user information in the social account. In some exemplary embodiments of the subject matter, the displaying of the winning notification notifies the social connection that won the online game of the win and may display the win on a social connection's account. Displaying the winning notification on the social connection's is account informs other user of the social network website of the online game and that the social connection was a winning selection.

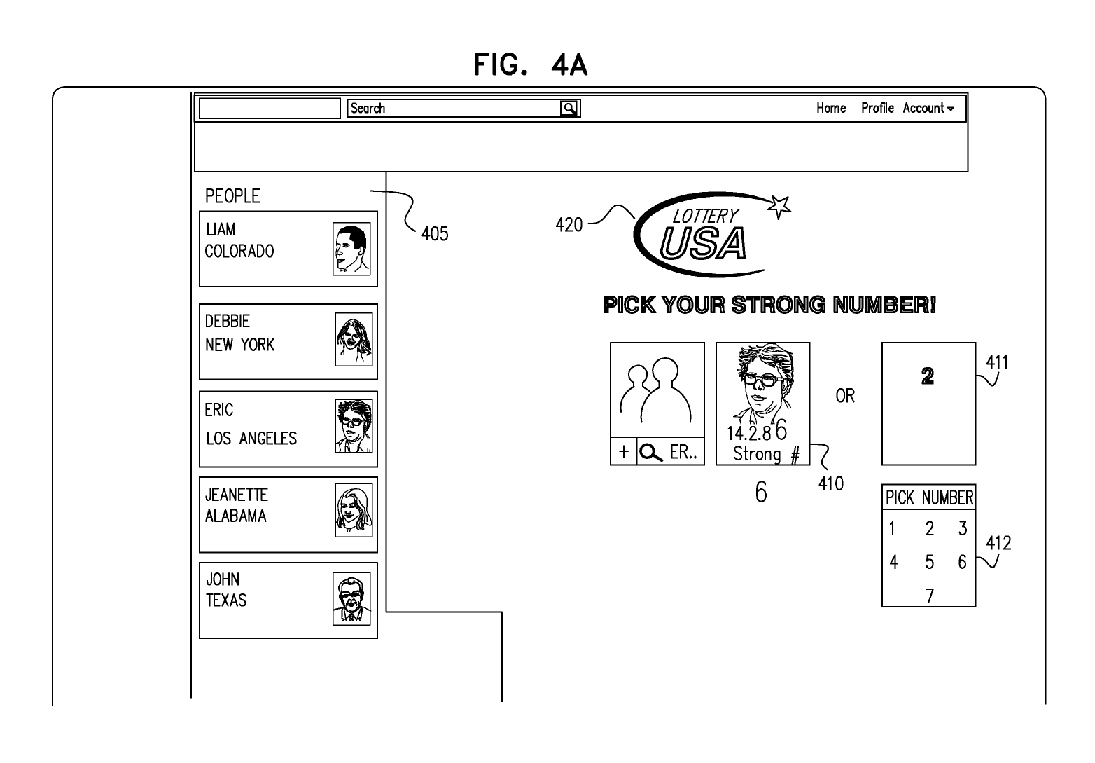

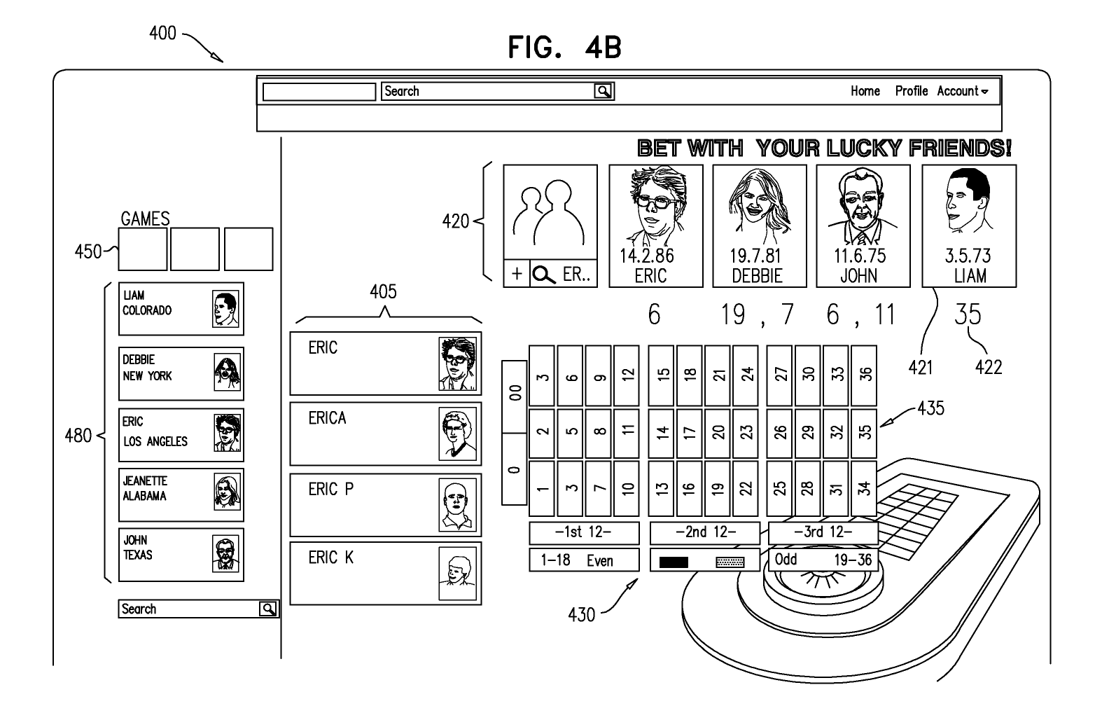

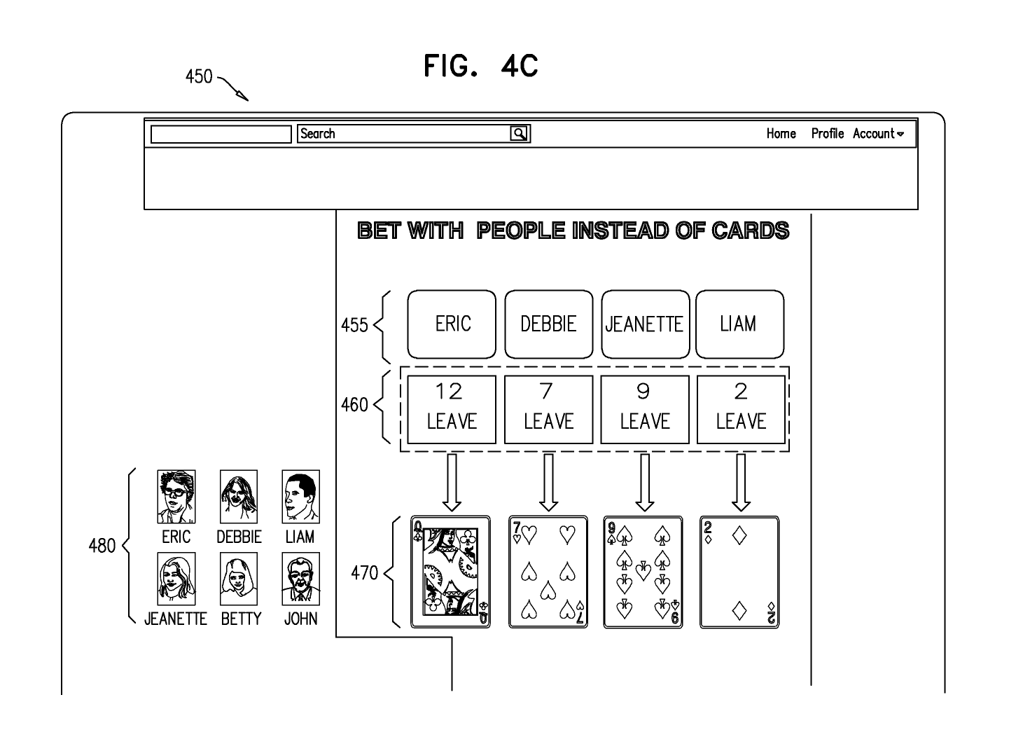

FIGS. 4A-4C shows a display for selecting one or more connections as inputs for an online game, according to some exemplary embodiments of the subject matter. FIG. 4A shows a display for selecting one or more connections for an online lottery game, according to some exemplary embodiments of the subject matter. The display 400 shows a user profile page on a social network website. The social network website comprises a selection of social connections 405 to be selected for participating in an online game, such as a lottery 420. The selection of social connections 405 may be displayed as a menu in which the social connections are displayed and the user selects one of the social connections from the menu using the input 210 of FIG. 2. The display 400 comprises a selected connections 410, which shows the social connections the user selected from the selection of social connections 405. In some cases, the user may select a different number 411 from a number selection 412.

FIG. 4B shows a display for selecting one or more social connections for an online roulette game, according to some exemplary embodiments of the subject matter. The display 400 shows a user profile page on a social network website. The social network website comprises a selection of social connections 405 to be selected for participating in the online game, such as roulette 430. Information of the social connections are generated into numbers that are used for input into the roulette 430. For example, the user selects four friends 4, such as Liam 421 which generates participation number thirty five 422. The number is selected on a roulette display 435. The display 400 may comprise a selection of other games 450. Some embodiments display playing connections 480, which shows which games are being played by social connections.

FIG. 4C shows a display for selecting one or more social connections for an online card game, according to some exemplary embodiment of the subject matter. The display 450 shows a user profile page on a social network website. The social network website comprises a selection of social connections 455 to be selected for participating in an online game, such as a card game 470. The information of the social connections, for example, a connection name, which is used to generate participation data 460.

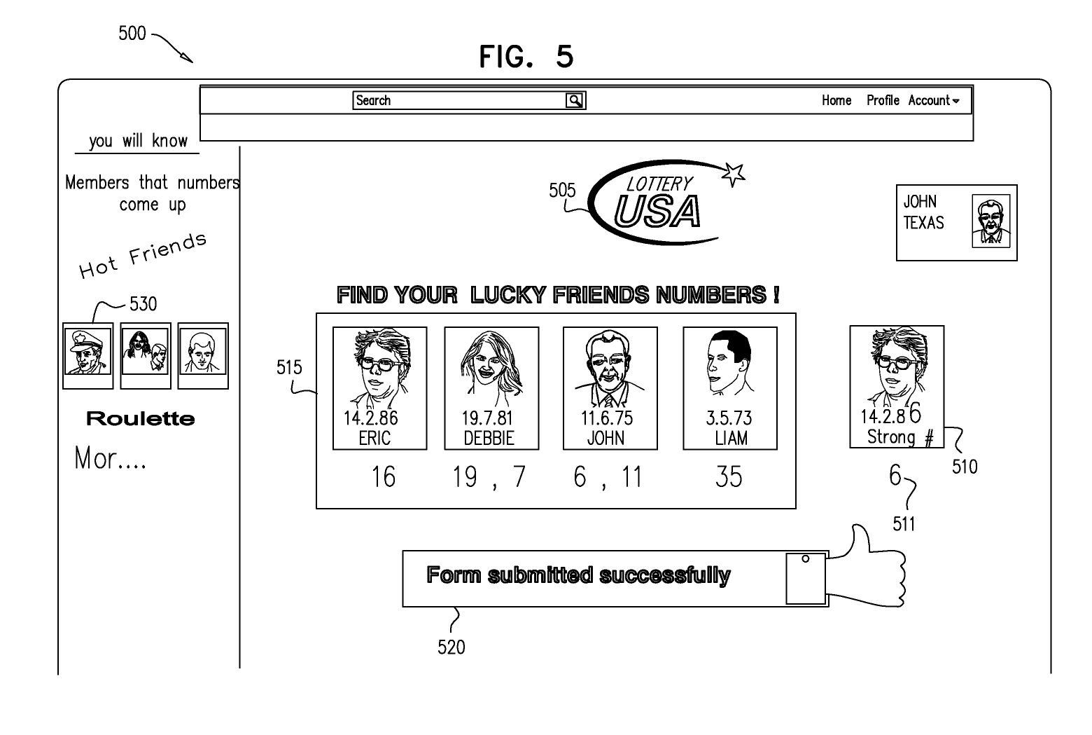

FIG. 5 shows a connection selection display, according to some exemplary embodiments of the subject matter. The display 500 shows a user account on a social network website. The user account shows an online game 505 a user participated in. The user account comprises a list 515 comprising social connections that were selected for playing the online game 505, for example. Strong 510 and Strong number 511. The list 515 comprises the is numbers generated and used as participation data in the online game 505. The display 500 comprises a participation complete message 520 to inform the user the participation data has been inputted into the online game and that the user is participating in the game. In some cases, the display 520 comprises a successful connections list 520, which displays social connections that were used as participation data with which the user won in online games. For example, the successful connections list 520 shows three social connections that are numbers with which the user won in the online game of roulette. In some exemplary embodiments of the subject matter, the display 500 provides a lucky friends display 530, which shows friends that generated participation data with which resulted in winning of online games.

While the disclosure has been described with reference to exemplary embodiments, it will be understood by those skilled in the art that various changes may be made and equivalents may be substituted for elements thereof without departing from the scope of the subject matter. In addition, many modifications may be made to adapt a particular situation or material to the teachings without departing from the essential scope thereof. Therefore, it is intended that the disclosed subject matter not be limited to the particular embodiment disclosed as the best mode contemplated for carrying out this subject matter, but only by the claims that follow.

1. A method, comprising:
accessing one or more social network website;
accessing an online game;
selecting one or more social connections from the social network website;
extracting social connection data of the one or more social connections from the social network website;
generating participation data from the social connection data; wherein the participation data enables participating in the online game; and,
inputting the one or more social connections into the online game.

2. The method of claim 1, further comprises generating participation data from connection information provided about a social connection of the one or more social connections from the social network website.

3. The method of claim 2, wherein the connection information used to generate the participation data is a birth date of a social connection.

4. The method of claim 2, wherein the generated participation data is randomly generated from the user account on the social network website.

5. The method of claim 1, further comprises displaying on the social network the social connections selected for the game.

6. The method of claim 1, further comprises determining a success probability of the social connection to generate winning participation data.

7. The method of claim 1, wherein the online game is a lottery.

8. The method of claim 1, wherein the online game is a card game.

9. The method of claim 1, wherein the online game is a roulette.

10. The method of claim 1, wherein the online game is bingo.

11. A computerized device, comprising:
an input for selecting a social connection from a social network website;
a participation data generation unit for generating participation data that is used to participate in an online game; wherein the participation data is generated from the social connection;
a communication unit to connect to a social network server to obtain access the social network website;
wherein the communication unit connects to one or more online game servers to enable playing an online game; wherein playing the online game comprises inputting participation data to enable playing the online game;
an output unit for displaying the one or more social connections selected as inputs for game input.

12. The computerized device of claim 11, wherein the selection of the one or more social connections is transmitted to the one or more social network servers.
